(19) United States
(12) Patent Application Publication
(10) Pub. No.: US 2014/0077654 A1
(43) Pub. Date: Mar. 20, 2014

(54) ROTOR OF MOTOR AND SYNCHRONOUS MOTOR HAVING THE SAME AND WOUND ROTOR SYNCHRONOUS MOTOR

(71) Applicant: Hyundai Motor Company, (US)

(72) Inventors: Kyoungbum Kim, Seongnam (KR); Hyoungjun Cho, Seoul (KR); Sanghoon Moon, Seongnam (KR); Sangjin Park, Hwaseong (KR); Jung Shik Kim, Seoul (KR)

(73) Assignee: HYUNDAI MOTOR COMPANY, Seoul (KR)

(21) Appl. No.: 13/710,094

(22) Filed: Dec. 10, 2012

(30) Foreign Application Priority Data
Sep. 17, 2012 (KR) 10-2012-0102852

(51) Int. Cl. H02K 1/22

(52) U.S. Cl. CPC H02K 1/223
USPC 310/181

(57) ABSTRACT

Disclosed is a rotor for a motor in a vehicle. More specifically, the rotor includes a rotation shaft serving as a center of rotation of the rotor, a core installed at the rotation shaft and comprising a plurality of teeth radially protruding with respect to the rotation shaft, a coil wound around the tooth to generate a magnetic field by an external power source, and a pair of permanent magnets installed at both sides of the teeth. Also disclosed is a synchronous motor including the rotor, and a wound rotor synchronous motor.

### CROSS-REFERENCE TO RELATED APPLICATION

This application claims priority to and the benefit of Korean Patent Application No. 10-2012-0102852 filed in the Korean Intellectual Property Office on Sep. 17, 2012, the entire contents of which are incorporated herein by reference.

### BACKGROUND

(a) Field of the Invention

The present invention relates to a rotor for a motor around which a coil is wound. Also disclosed is a synchronous motor including the rotor, and a wound rotor synchronous motor.

(b) Description of the Related Art

Electric vehicles provide driving power typically from either a DC motor, an induction motor, or a permanent magnet synchronous motor, which are each connected to an appropriate power converter. These motors may be any one of a plurality of configurations. Among them, an internal permanent magnet (IPM) motor capable of obtaining a uniform power operation for a wide range of speeds is primarily used in electric vehicles (EV) and hybrid electric vehicles (HEV).

However, in the IPM motor, a rare earth permanent magnet is generally disposed inside a rotor. Accordingly, it is often impossible to control a power factor to 1, and a cost of the IPM motor increases substantially due to the cost earth rare permanent magnets. Accordingly, a motor which does not use a rare earth permanent magnet has been developed, and a switched reluctance motor (SRM), a synchronous reluctance motor (SRM), and a wound rotor synchronous motor (WRSM) which also do not use a permanent magnet has specifically been recently developed as alternatives to the IPM.

Among them, especially, the wound rotor synchronous motor (WRSM) is a motor capable of achieving a minimum size while having a torque density and an output density similar to those of the IPM motor. Also, the wound rotor synchronous motor (WRSM) does not use the rare earth permanent magnet, so that a cost of the motor may be reduced.

However, in the wound rotor synchronous motor (WRSM), a coil is wound around a rotor instead of the permanent magnet and a large amount of additional current needs to be supplied. Therefore copper loss often occurs in the coil of the rotor due to the high volume of current therein, thereby deteriorating efficiency.

The above information disclosed in this Background section is only for enhancement of understanding of the background of the invention and therefore it may contain information that does not form the prior art that is already known in this country to a person of ordinary skill in the art.

### SUMMARY

The present invention has been made in an effort to provide a rotor of a motor capable of improving energy efficiency while reducing the cost of the motor by replacing an IPM motor (which is typically applied to a hybrid electric vehicle or an electric vehicle), a synchronous motor including the rotor, and a wound rotor synchronous motor. In order to solve the aforementioned problem, an exemplary embodiment of the present invention provides a rotor for a motor. In several exemplary embodiments, the rotor of the motor includes a rotation shaft serving as a center of rotation for the rotor; a core installed within the rotation shaft and comprising a plurality of teeth radially protruding with respect to the rotation shaft; a coil wound around the tooth to generate a magnetic field by an external power source; and a pair of permanent magnets installed on both sides of the teeth.

The teeth may include extended portions extending from ends of the teeth toward both sides so as to be matched with an inner diameter surface of a stator of the motor. Furthermore, the pair of permanent magnets may be installed between the extended portions and the coil. The extended portions may include a pair of grooves at both sides of the teeth, and the pair of permanent magnets may be inserted in the pair of grooves. The permanent magnet may be a ferrite magnet.

Another exemplary embodiment of the present invention provides a synchronous motor. In several exemplary embodiments, the synchronous motor includes: a cylindrical stator configured to form a magnetic field from an external power source; and a rotor rotating inside the stator.

The stator may include a stator core formed around the outer perimeter of the stator, a plurality of stator teeth protruding toward an inside of the stator core in a radial direction at uniform intervals, and a stator coil wound around the stator tooth to generate a magnetic field.

In yet another exemplary embodiment of the present invention provides a wound rotor synchronous motor (WRSM) in which a coil is wound around a rotor. In several exemplary embodiments, the rotor of the wound rotor synchronous motor is the rotor for the motor.

According to the wound rotor including the permanent magnet and the synchronous motor including the wound rotor according to the exemplary embodiment of the present invention, it is possible to appropriately replace the IPM motor and reduce a cost of the motor by using the ferrite magnet and the wound rotor together. Further, according to the wound rotor including the permanent magnet and the synchronous motor including the wound rotor according to the exemplary embodiment of the present invention, copper loss is decreased by 36% compared to the conventional wound rotor synchronous motor, thereby improving efficiency of the motor.

### BRIEF DESCRIPTION OF THE DRAWINGS

FIG. 1 is a cross-sectional view of a synchronous motor according to a first exemplary embodiment of the present invention.

FIG. 2 is an enlarged view of a part A1 of a synchronous motor according to a first exemplary embodiment of the present invention.

FIG. 3 is an enlarged view of a part of a synchronous motor according to a second exemplary embodiment of the present invention.

FIG. 4 is a cross-sectional view of a wound rotor synchronous motor without a permanent magnet.

FIG. 5 is a cross-sectional view of a wound rotor synchronous motor provided with a permanent magnet according to an exemplary embodiment of the present invention.

### DETAILED DESCRIPTION OF THE EMBODIMENTS

Hereinafter, exemplary embodiments of the present invention will be described in detail with reference to the accompanying drawings.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

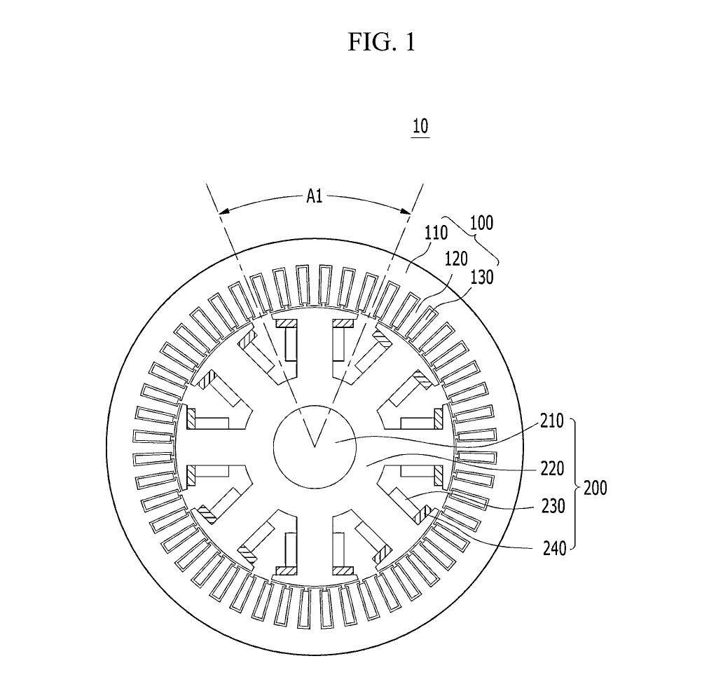

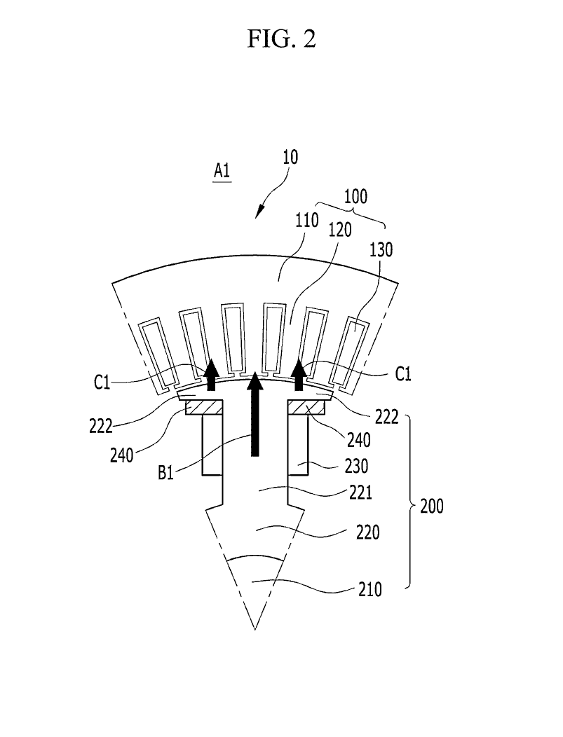

FIG. 1 is a cross-sectional view of a synchronous motor 10 according to a first exemplary embodiment of the present invention, and FIG. 2 is an enlarged view of a part A1 of the synchronous motor 10 according to the first exemplary embodiment of the present invention.

As illustrated in FIGS. 1 and 2, the synchronous motor 10 according to the first exemplary embodiment of the present invention includes a stator 100 and a rotor 200. The synchronous motor rotates an internal magnetic pole in the same direction and at the same speed by rotating an external magnetic pole while opposing the external magnetic pole and the internal magnetic pole having different magnetic polarities, and is called a synchronous electric motor. The synchronous motor may adjust a power factor by a change in an exciter, continue the rotation at a synchronous speed even though a load changes, and has improved efficiency compared to the conventional motors, so that the synchronous motor may be used as a large capacity motor.

The stator 100 may be fixedly mounted inside a housing of the synchronous motor 10, and form a magnetic field via an external power source. As illustrated in FIG. 1, the stator 100 according to the exemplary embodiment of the present invention includes a stator core 110 formed around an outer perimeter thereof, a plurality of stator teeth 120 protruding toward an inside of the stator core 110 in a radial direction at uniform intervals, and a stator coil 130 wound around the stator tooth 120 to generate a magnetic field.

In one or multiple exemplary embodiments, the stator core 110 may be formed in a shape of a concentric circle, that is, a circular ring, so as to sufficiently form a rotating magnetic field, and may be made of a metal material. The stator tooth 120 may be integrally formed with the stator core 110, and may be arranged while being spaced apart from an inside of the stator core 110 at predetermined intervals. Accordingly, a slot that is a space wound with the stator coil 130 is formed between the adjacent stator tooth 120. The number of stator teeth 120 is not limited to that of the exemplary embodiment of the present invention, and may be appropriately adjusted for a stable driving characteristic of the motor.

In one or multiple exemplary embodiments, as illustrated in FIGS. 1 and 2, the stator teeth 120 may extend along both sides in a circumferential direction so that a shape of an end portion thereof protruding inward the stator core 110 corresponds to that of the rotor 200.

The rotor 200 is installed inside the stator 100 to be rotated via magnetic action with the stator 100, and may include a rotation shaft 210, a core 220, a coil 230, and a permanent magnet 240 as illustrated in FIGS. 1 and 2. The rotation shaft 210 is a shaft serving as a center of rotation (axis) of the rotor 200, and may be formed to have a circular cross section.

The core 220 is a part serving as a main body of the rotor 200, and may be installed in close contact with to an outer diameter surface of the rotation shaft 210 as illustrated in FIG. 1, and may include a plurality of teeth 221 radially protruding with respect to the rotation shaft 210. The number of teeth 221 is not limited to that of the exemplary embodiment of the present invention, and may be appropriately adjusted for a stable driving characteristic of the motor. In one or multiple exemplary embodiments, as illustrated in FIGS. 1 and 2, the teeth 221 may include extended portions 222 of which ends extend in a circumferential direction so as to be matched to an inner diameter surface of the stator 110.

The coil 230 is wound around the tooth 221 to generate a magnetic field via an external power source. Contrary to the conventional internal permanent magnet (IPM) motor in which the permanent magnet is inserted into the rotor, in the synchronous motor 10 according to the exemplary embodiment of the present invention, a current is supplied to the coil 230 wound around the rotor 200 to generate the magnetic field.

Accordingly, the synchronous motor 10 according to the exemplary embodiment of the present invention may be a wound rotor synchronous motor (WRSM). In the conventional IPM motor, it is necessary to apply an additional current in order to decrease a magnetic flux generated in the rotor by the permanent magnet when operating at high speeds Therefore, a large amount of current needs to be applied to the stator, which is inefficient and problematic. However, the wound rotor synchronous motor (WRSM) 10 according to the exemplary embodiment of the present invention may adjust the magnetic flux of the rotor 200 by controlling a current flowing through the coil 230 wound around the tooth 221 of the rotor 200 at high speeds. Therefore additional current is not needed to weaken the field at high speeds.

Further, the IPM motor in the related art requires a large capacitor on a DC link terminal side of the motor system in order to increase a power factor. IN the exemplary embodiment of the present invention, however, the wound rotor synchronous motor may control a power factor to 1 by controlling the current flowing through the coil 230 wound around the rotor 200, thereby decreasing the size of the capacitor of the DC link terminal required.

The permanent magnets 240 may be installed at both sides of the teeth 221 to generate a magnetic field. That is, a pair of permanent magnets 240 may additionally be installed on both sides of the rotor 200 of the wound rotor synchronous motor (WRSM) 10 according to the exemplary embodiment of the present invention, thereby further improving efficiency of the motor. Since the magnetic flux is continuously generated by the pair of permanent magnets 240 installed at the rotor 200, it is possible to decrease a current applied to the rotor 200 of the motor and thus decrease copper loss of the coil 230 wound around the rotor 200, thereby further improving the efficiency of the wound rotor synchronous motor (WRSM).

As illustrated in FIGS. 1 and 2, according to the first exemplary embodiment of the present invention, the extended portions 222 and the coils 230 formed at both sides of the teeth 221 of the rotor 200 are formed while being spaced apart from each other, so that predetermined spaces may be formed therebetween, and the pair of permanent magnets 240 may be installed within these spaces, respectively.

In the synchronous motor 10 according to the first exemplary embodiment of the present invention, as illustrated in FIG. 2, the magnetic flux is generated in direction B1 by the coil 230 wound around the tooth 221 of the rotor 200. Further, the magnetic flux is generated in direction C 1 by the permanent magnets 240 on both sides of the teeth 221. Accordingly, the magnetic flux B1 generated by the coil 230 of the rotor 200 may be transferred to the stator 100 without hindrance of the permanent magnets 240. Since the permanent magnet 240 generally has magnetic resistance similar to air, when the permanent magnet 240 is installed in a straight line with respect to direction B1 in which the magnetic flux is generated by the coil 230, the magnetic flux B1 by the coil 230 is blocked, so that the efficiency of the motor may be deteriorated. However, according to the first exemplary embodiment of the present invention, since the permanent magnets 240 are installed by forming the spaces at both sides of the teeth 221. As a result, magnetic flux C1 of the permanent magnets 240 may be added without hindering the magnetic flux B1 by the coil 230.

In one or multiple exemplary embodiments, the permanent magnet 240 may be a ferrite magnet. In general, the ferrite magnet is cheaper than the rare earth magnet, so that a cost of the synchronous motor 10 may be reduced. Ferrite is a common name of magnetic ceramic containing oxidized steel. However, the ferrite magnet is merely the exemplary embodiment, the type of permanent magnet 240 is not limited to the ferrite magnet and therefore in some instances the rare earth magnet and the like may be used depending on a case.

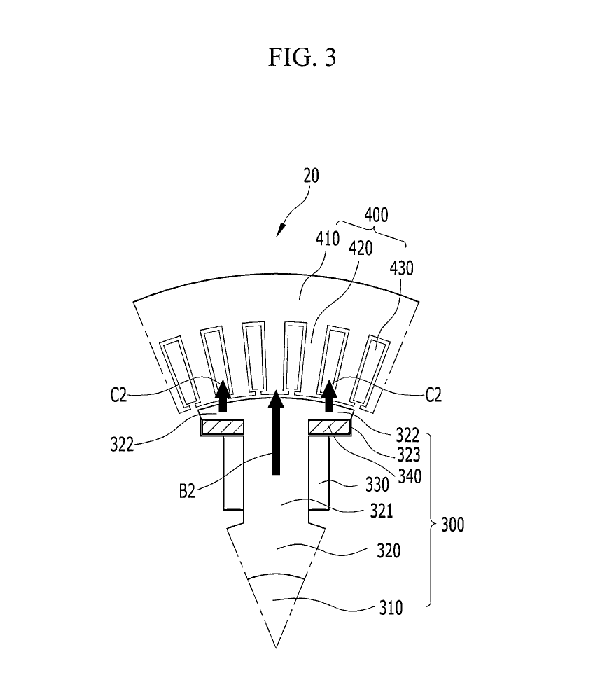

FIG. 3 is a cross-sectional view illustrating a synchronous motor 20 according to a second exemplary embodiment of the present invention. As illustrated in FIG. 3, the synchronous motor 20 according to the second exemplary embodiment of the present invention also includes a stator 400 and a rotor 300 similar to the first exemplary embodiment. That is, the basic configuration of the synchronous motor 20 according to the second exemplary embodiment of the present invention is substantially the same as the synchronous motor 10 according to the first exemplary embodiment of the present invention, so that a different configuration will be described in detail below.

The rotor 300 of the synchronous motor 20 according to the second exemplary embodiment of the present invention may include a rotation shaft 310 serving as a center of rotation (axis), a core 320 installed at the rotation shaft 310 and including a plurality of teeth 321 radially protruding with respect to the rotation shaft 310, a coil 330 wound around the tooth 321 to generate a magnetic field by an external power source, and a pair of permanent magnets 340 installed at both sides of the teeth 321, and the teeth 321 may include extended portions 322 extending from ends of the teeth 321 toward both sides so as to be matched with an inner diameter surface of the stator 400.

According to the second exemplary embodiment of the present invention, as illustrated in FIG. 3, the extended portions 322 of the teeth 321 are installed in close contact with an upper part of the coil 330, and a pair of grooves 323 is formed under both sides of the extended portions 322. The permanent magnets 340 are inserted in the grooves 323, respectively.

Accordingly, the synchronous motor 20 according to the second exemplary embodiment of the present invention is simply different from the synchronous motor 10 according to the first second exemplary embodiment of the present invention in terms of the installation structure of the permanent magnet, but the substantial action and effect thereof are the same as those of the synchronous motor 10 according to the first exemplary embodiment.

That is, as illustrated in FIG. 3, in the synchronous motor 20 according to the second exemplary embodiment of the present invention, magnetic flux B2 generated by the coil 330 of the rotor 300 is not hindered by the permanent magnets 230, and magnetic flux C2 generated by the permanent magnets 340 is added, thereby further improving efficiency of the synchronous motor 20. In the synchronous motor 20 according to the second exemplary embodiment of the present invention, the ferrite magnet may be used as the permanent magnet 340, but the type of permanent magnet 340, like the first exemplary embodiment, is not limited to the ferrite magnet, and in some instances the rare earth magnet and the like may be used depending on a case.

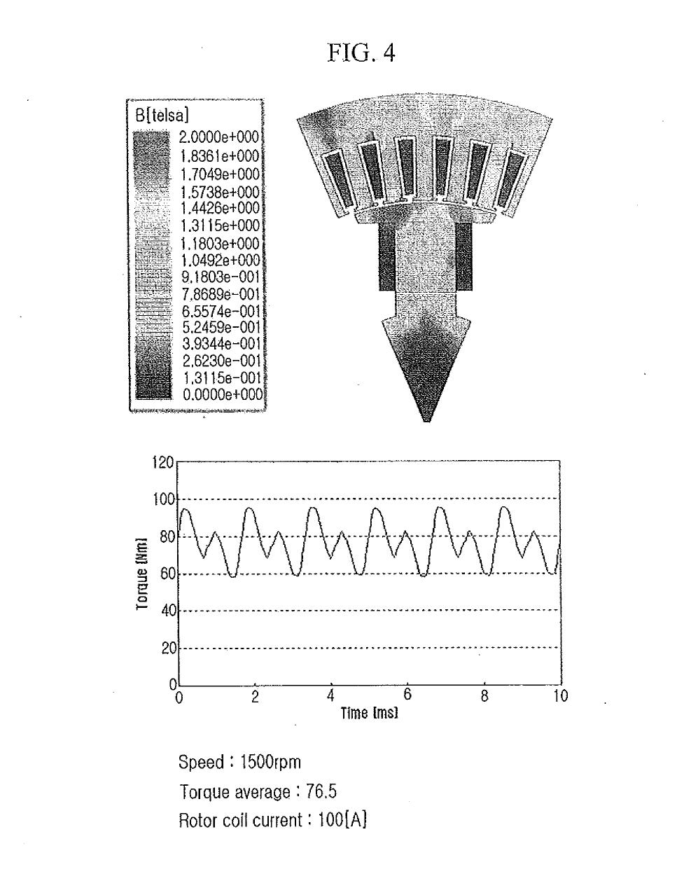

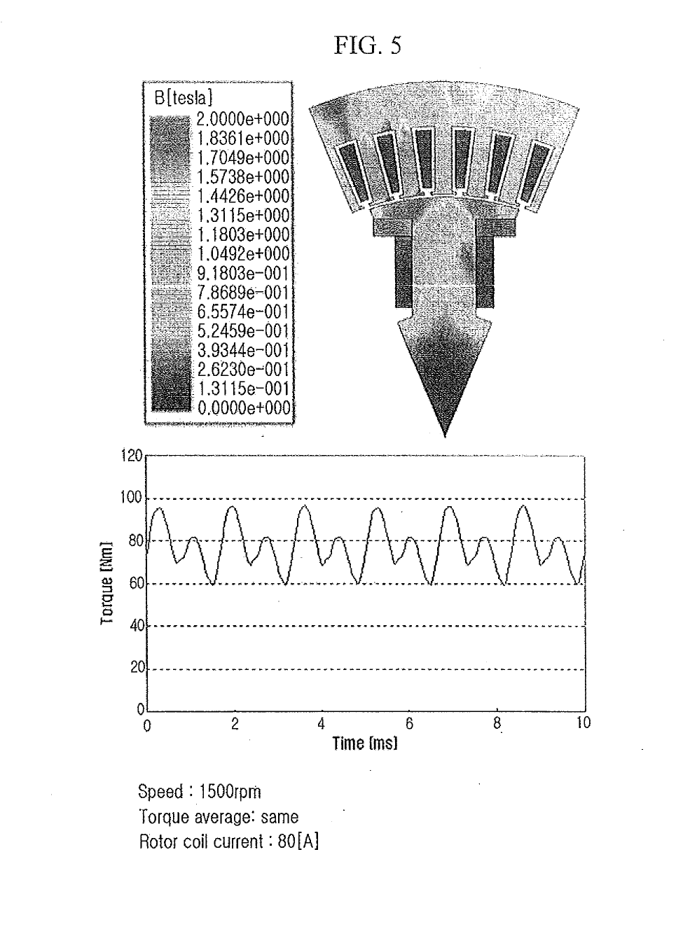

FIG. 4 is a graph illustrating a characteristic of a wound rotor synchronous motor without a permanent magnet, and FIG. 5 is a graph illustrating a characteristic of the wound rotor synchronous motor 10 provided with the permanent magnet 240 according to the exemplary embodiment of the present invention.

Comparing FIG. 4 and FIG. 5, when generating the same torque at the same speed (RPM), a current applied to the rotor of the wound rotor synchronous motor of FIG. 4 without a permanent magnet is illustrated as 100 A, and a current applied to the rotor of the wound rotor synchronous motor 10 of FIG. 5 provided with the permanent magnet according to the exemplary embodiment of the present invention is illustrated 80 A. Further, as illustrated in the cross-sectional views of the synchronous motors of FIGS. 4 and 5, it can be seen that characteristics of the magnetic flux densities are exhibited in a similar shape. Accordingly, it can be identified that the synchronous motors 10 and 20 according to the exemplary embodiments of the present invention may decrease the applied current while exhibiting the same effect as that illustrated in FIG. 4.

Further, copper loss is calculated by multiplying a square root of the current by resistance, so that the copper loss is proportional to the square root of the current. Accordingly, in the rotor of the wound rotor synchronous motor 10 according to the exemplary embodiment of the present invention of FIG. 5 through which a current of 80 A flows, the copper loss is decreased by 36% compared to the case of FIG. 4 through which a current of 100 A flows, thereby improving efficiency of the motor.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

<Description of symbols>

| | |
|---|---|
| 10, 20: Synchronous motor | 100, 400: Stator |
| 200, 300: Rotor | 110, 410: Stator core |
| 120, 420: Stator teeth | 130, 430: Stator coil |
| 210: 310: Rotation shaft | 220, 320: Core |
| 221, 321: Teeth | 222, 322: Extended portion |
| 323: Groove | 230, 330: Coil |
| 240, 340: Permanent magnet | |

What is claimed is:

1. A rotor of a motor, comprising:
a rotation shaft serving as a center of rotation of the rotor;
a core installed at the rotation shaft and comprising a plurality of teeth radially protruding with respect to the rotation shaft;
a coil wound around the plurality of teeth to generate a magnetic field via an external power source; and
at least one permanent magnet installed around a respective tooth of the plurality of the teeth.

2. The rotor of claim 1, wherein:
the respective teeth include an extended portion circumferentially extending from ends of the respective tooth so as to be matched with an inner diameter surface of a stator of the motor.

3. The rotor of claim 2, wherein:
the at least one permanent magnet is installed between the extended portion and the coil.

4. The rotor of claim 2, wherein:
the extended portion forms a groove on both sides of the respective tooth, and the at least one permanent magnet is inserted in groove.

5. The rotor of claim 1, wherein:
the permanent magnet is a ferrite magnet.

6. A synchronous motor, comprising:
a cylindrical stator configured to form a magnetic field via an external power source; and
a rotor rotating inside the stator, the rotor including,
a rotation shaft serving as a center of rotation of the rotor;
a core installed at the rotation shaft and comprising a plurality of teeth radially protruding with respect to the rotation shaft;
a coil wound around the plurality of teeth to generate a magnetic field via an external power source; and
at least one permanent magnet installed around a respective tooth of the plurality of the teeth.

7. The synchronous motor of claim 6, wherein the stator comprises:
a stator core formed along the outer perimeter of the stator;
a plurality of stator teeth protruding toward an inside of the stator core in a radial direction at uniform intervals; and
a stator coil wound around the plurality of stator teeth to generate a magnetic field.

8. A wound rotor synchronous motor (WRSM) having a coil wound around a rotor according to claim 1.
